(19) United States
(12) Patent Application Publication
(10) Pub. No.: US 2011/0235000 A1
(43) Pub. Date: Sep. 29, 2011

(54) PROJECTOR

(75) Inventor: Toshihiro SHIMIZU, Matsumoto-shi (JP)

(73) Assignee: SEIKO EPSON CORPORATION, TOKYO (JP)

(21) Appl. No.: 13/046,226

(22) Filed: Mar. 11, 2011

(30) Foreign Application Priority Data
Mar. 29, 2010 (JP) 2010-075012

(51) Int. Cl. G03B 21/14

(52) U.S. Cl. 353/97

(57) ABSTRACT

A projector includes: an illuminator that emits illumination light; a light modulator that modulates the illumination light emitted from the illuminator; and a projection system that includes a plurality of lenses and a diaphragm and projects the light modulated by the light modulator, wherein the projection system includes a support that supports at least one of the following lenses: a lens located on the object side of the diaphragm in the nearest position therefrom and a lens located on the image side of the diaphragm in the nearest position therefrom, and the support partially supports the outer circumference of the lens.

### BACKGROUND

1. Technical Field

The present invention relates to a projector that projects an image formed by a liquid crystal panel or any other light modulator.

2. Related Art

There has been a projector of related art including a zoom-type projection lens that enlarges and projects an image formed, for example, by a liquid crystal panel (see JP-A-2004-109896, for example).

In the projection lens of related art, however, a lens support frame is made of a resin in many cases. In this case, when the support frame is irradiated with projection light for a long period, the portion of the support frame where the light flux converges is distorted, so that a lens is displaced, disadvantageously resulting in decrease in resolution. Irradiation of the projection light for a long period also increases the temperature of a lens disposed in a position where the light flux converges, disadvantageously resulting in temperature drift and unstable projection of a highly precise image.

### SUMMARY

An advantage of some aspects of the invention is to provide a projector capable of readily preventing a frame for supporting a lens and the lens itself from being heated and projection performance of the lens from being degraded.

A projector according to an aspect of the invention includes an illuminator that emits illumination light, a light modulator that modulates the illumination light emitted from the illuminator, and a projection system that includes a plurality of lenses and a diaphragm and projects the light modulated by the light modulator. The projection system includes a support that supports at least one of the following lenses: a lens located on the object side of the diaphragm in the nearest position therefrom and a lens located on the image side of the diaphragm in the nearest position therefrom, and the support partially supports the outer circumference of the lens.

In the projector described above, since the support partially supports the outer circumference of the lens, which is disposed adjacent to the diaphragm, the amount of light blockage outside the outer circumference of the lens can be reduced, while the outer circumference of the lens is effectively used. In this way, the lens and the support for supporting the lens, which are disposed adjacent to the diaphragm and where a light flux tends to converge, will not be heated, whereby the lens and the support for supporting the lens will not be distorted due to expansion thereof. That is, the performance of the projection system can be maintained at a high level at all times.

In a specific embodiment or aspect, the projector may be configured such that the support is made of a resin. In this case, the support tends to expand or distort due to heat, but the amount of distortion of the lens and the support can be reliably reduced because the support partially supports the outer circumference of the lens as described above.

In another aspect, the projector may be configured such that a gap that allows ventilation is created between the support and the outer circumference of the lens. In this case, since the outer circumference of the lens, which is disposed adjacent to the diaphragm and where a light flux tends to converge, can be cooled by the ventilation, the characteristics of the projection system can be readily maintained.

In still another aspect, the projector may be configured such that the support supports the outer circumference of the lens at a plurality of circumferential locations spaced apart from each other. The configuration allows uniform support because support points are distributed.

In yet another aspect, the projector may be configured such that the projection system is a zoom lens in which the distances between the plurality of lenses are relatively changed. In this case, although a light flux tends to be incident on the outer circumference of a specific lens disposed in the vicinity of the diaphragm at a high density, the performance of the projection system can be maintained at a high level because the lens will not be heated.

### BRIEF DESCRIPTION OF THE DRAWINGS

The invention will be described with reference to the accompanying drawings, wherein like numbers refer to like elements.

FIG. 1 conceptually describes the structure of a projector according to an embodiment of the invention.

FIG. 2 is a longitudinal cross-sectional view of a projection system incorporated in the projector shown in FIG. 1.

FIG. 3A is a side cross-sectional view and FIG. 3B is a front view and FIGS. 3A and 3B describe a specific lens adjacent to a diaphragm and a support for supporting the specific lens.

### DESCRIPTION OF EXEMPLARY EMBODIMENTS

A projector according to an embodiment of the invention will be described below in detail with reference to the drawings.

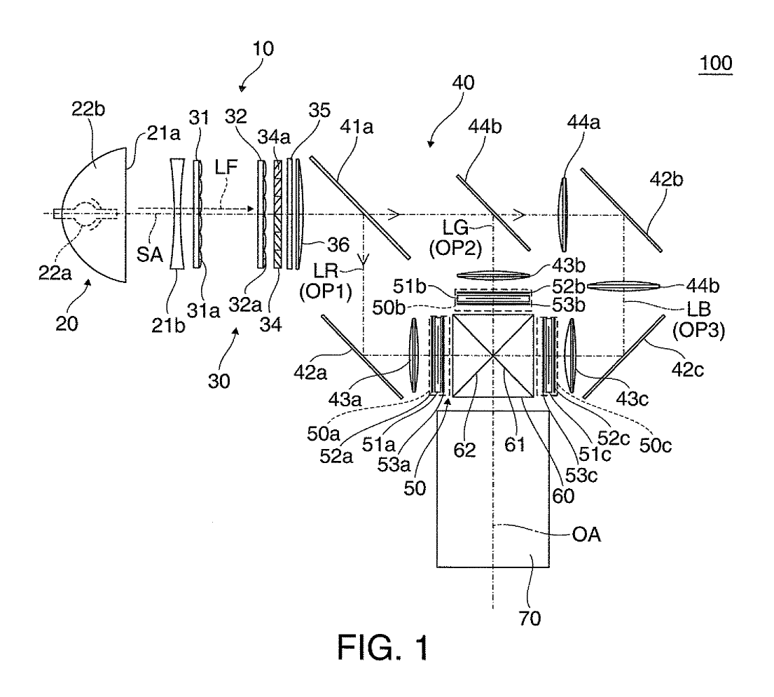

As shown in FIG. 1, a projector 100 includes an illuminator 10, a color separation/light guiding section 40, a light modulating section 50, a light combining section 60, and a projection system 70.

First of all, the illuminator 10 includes a light source lamp unit 20 and a homogenizing system 30. In the illuminator 10, the light source lamp unit 20 includes a lamp unit 21a as a light source and a concave lens 21b. The lamp unit 21a includes an arc tube 22a, such as a high-pressure mercury lamp, and an ellipsoidal concave mirror 22b that reflects the light flux emitted from the arc tube 22a and directs the light flux forward. The concave lens 21b serves to align the illumination light flux LF from the lamp unit 21a substantially in parallel to a system optical axis SA but can be omitted when the concave mirror 22b is, for example, a paraboloidal mirror.

The homogenizing system 30 includes first and second lens arrays 31, 32, a polarization conversion member 34, and a superimposing lens 36. Among the components described above, a plurality of element lenses 31a that form the first lens array 31 divide the illumination light flux LF having exited from the light source lamp unit 20 into a plurality of sub-light fluxes. A plurality of element lenses 32a that form the second lens array 32 cause the sub-light fluxes incident thereon from the first lens array 31 to exit toward the polarization conversion member 34 with an appropriate angle of divergence. The polarization conversion member 34 has prism-shaped polarization conversion elements 34a arranged in an array, each of which includes a PBS, a mirror, and a half-wave plate. The polarization conversion member 34 converts the illumination light flux LF having exited through the lens array 32 only into light linearly polarized in a specific direction and supplies it to downstream optical system. The superimposing lens 36 causes the illumination light flux LF having exited through the second lens array 32 and passed through the polarization conversion member 34 to converge as a whole appropriately, allowing superimposed illumination on liquid crystal light valves 50a, 50b, and 50c for respective colors provided in the light modulating section 50.

The color separation/light guiding section 40 includes first and second dichroic mirrors 41a, 41b, reflection mirrors 42a, 42b, and 42c, three field lenses 43a, 43b, and 43c, and relay lenses 44a and 44b. The color separation/light guiding section 40 divides the illumination light flux LF having exited from the illuminator 10 into red (R), green (G), and blue (B) three color light fluxes and guides them to the respective downstream liquid crystal light valves 50a, 50b, and 50c. More specifically, the first dichroic mirror 41a first reflects R illumination light LR out of the RGB three color light fluxes and transmits G illumination light LG and B illumination light LB. The second dichroic mirror 41b then reflects the G illumination light LG out of the G and B two color light fluxes and transmits the B illumination light LB. That is, the red light LR reflected off the first dichroic mirror 41a is guided to a red-light optical path OP1 where the field lens 43a is disposed. The green light LG passing through the first dichroic mirror 41a and reflected off the second dichroic mirror 41b is guided to a green-light optical path OP2 where the field lens 43b is disposed. The blue-light LB passing through the second dichroic mirror 41b is guided to a blue-light optical path OP3 where the field lens 43c is disposed. The filed lenses 43a, 43b, and 43c for the respective colors adjust the angle of incidence of the sub-light fluxes having exited through the second lens array 32, passed through the superimposing lens 36 and other components, and entered the light modulating section 50 in such a way that each of the sub-light fluxes has an appropriate degree of convergence or divergence with respect to the system optical axis SA on illuminated areas of the liquid crystal light valves 50a, 50b, and 50c.

The light modulating section 50 includes the three liquid crystal light valves 50a, 50b, and 50c, on which the three color illumination light fluxes LR, LG, and LB divided from the illumination light flux LF are incident, as three light modulators illuminated with the three color illumination light fluxes LR, LG, and LB. The liquid crystal light valves 50a, 50b, and 50c respectively include liquid crystal panels 51a, 51b, and 51c, light incident-side polarization filters 52a, 52b, and 52c, and light exiting-side polarization filters 53a, 53b, and 53c. The liquid crystal panels 51a, 51b, and 51c, which are central components in the optical paths, are sandwiched between the light incident-side polarization filters 52a, 52b, and 52c, which are upstream components in the optical paths, and the light exiting-side polarization filters 53a, 53b, and 53c, which are downstream components in the optical paths. The color light fluxes LR, LG, and LB incident on the liquid crystal light valves 50a, 50b, and 50c undergo intensity modulation on a pixel basis in accordance with drive signals or control signals inputted as electric signals to the liquid crystal light valves 50a, 50b, and 50c.

The light combining section 60 is a cross dichroic prism for producing a combined color image and has a first dichroic film 61 for reflecting R light and a second dichroic film 62 for reflecting B light disposed in an X shape in a plan view. In the light combining section 60, the first dichroic film 61 reflects the red light LR from the liquid crystal light valve 50a, which is the light modulator for R light, and allows the red light LR to exit out of the cross dichroic prism rightward when viewed in the direction in which the R light travels. The dichroic films 61 and 62 allow the green light LG from the liquid crystal light valve 50b, which is the light modulator for G light, to travel straight and exit out of the cross dichroic prism. The second dichroic film 62 reflects the blue light LB from the liquid crystal light valve 50c, which is the light modulator for B light, and allows the blue light LB to exit out of the cross dichroic prism leftward when viewed in the direction in which the B light travels.

The projection system 70 is a zoom lens and projects image light fluxes, which have been outputted from the liquid crystal light valves 50a, 50b, and 50c and combined in the light combining section 60, on a screen (not shown) as a color image.

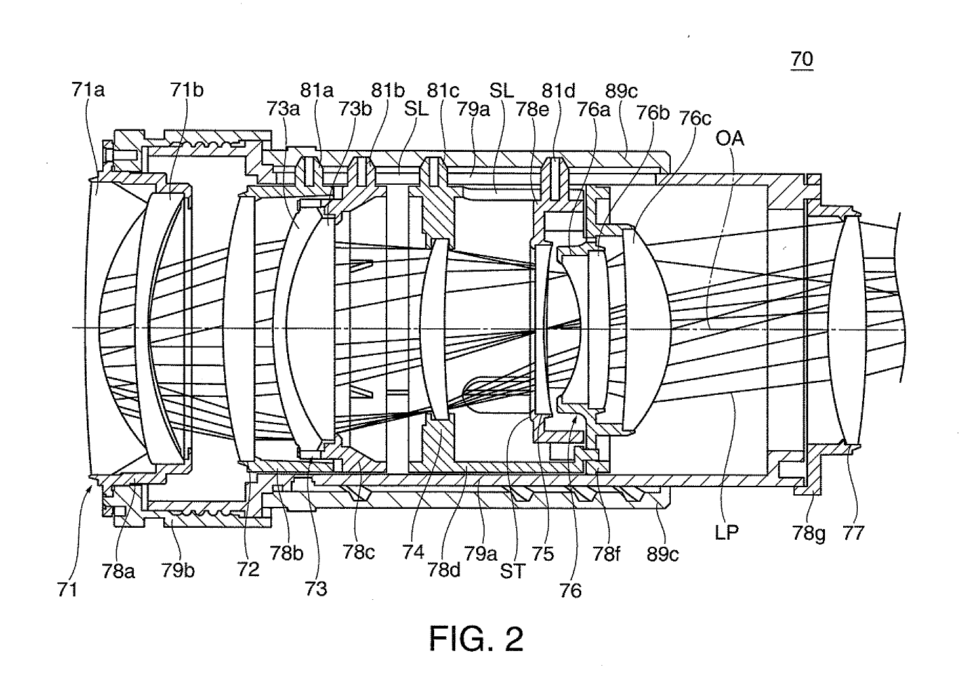

FIG. 2 is a longitudinal cross-sectional view for describing a specific exemplary configuration of the projection system 70. The projection system 70 includes a first group 71, a second group 72, a third group 73, a fourth group 74, a fifth group 75, a sixth group 76, a seventh group 77, and a diaphragm ST arranged in this order from the image side toward the object side. The projection system 70 is supported by a barrel body 79a made of a resin. Among the groups described above, the first group 71 includes a first lens 71a made of glass and having negative refracting power and a second lens 71b that is a negative doublet. The third group 73 includes a first lens 73a made of glass and having negative refracting power and a second lens 73b made of glass, having positive refracting power, and glued to the first lens 73a. The sixth group 76 includes a first lens 76a made of glass and having negative refracting power, a second lens 76b made of glass, having positive refracting power, and glued to the first lens 76a, and a third lens 76c made of glass and having positive refracting power. The second group 72 is formed of a single lens made of glass and having positive refracting power. The fourth group 74 is formed of a single lens made of glass and having positive refracting power. The fifth group 75 is formed of a single lens made of glass and having negative refracting power. The seventh group 77 is formed of a single lens made of glass and having positive refracting power. The first group 71 is supported by a support 78a, which is made of a resin, and fixed to a focus ring 79b that engages with a front end portion of the barrel body 79a. The second group 72 is supported by a support 78b made of a resin and held on the front end side (image side) in the barrel body 79a in such a way that the second group 72 can slide along an optical axis OA. The third group 73 is supported by a support 78c made of a resin and held on the object side of the second group 72 in the barrel body 79a in such a way that the third group 73 can slide along the optical axis OA. The fourth group 74 is supported by a support 78d made of a resin and held on the object side of the third group 73 in the barrel body 79a in such a way that the fourth group 74 can slide along the optical axis OA. The fifth group 75 is supported by a support 78e made of a resin and held on the object side of the fourth group 74 in the support 78d for supporting the fourth group 74 in such a way that the fifth group 75 can slide along the optical axis OA. The image side of the support 78e serves not only as a support frame but also as the diaphragm ST. The sixth group 76 is supported by a support 78f made of a resin and fixed to a rear end portion (object-side portion) of the support 78d for supporting the fourth group 74. The seventh group 77 is supported by a support 78g made of a resin and fixed to a rear end portion (object-side portion) of the barrel body 79a.

The second group 72 has a zoom pin 81a provided on the outer circumference of the support 78b for supporting the second group 72. The zoom pin 81a can be moved along a groove SL provided in the barrel body 79a in the direction of the optical axis OA. The zoom pin 81a slides along a cam groove provided in the inner surface of a zoom ring 89c made of a resin and fitting around the outer circumference of the barrel body 79a rotatably around the optical axis OA so that the position to which the support 78b or the second group 72 is moved is adjusted. The third group 73 has a zoom pin 81b provided on the outer circumference of the support 78c for supporting the third group 73. The zoom pin 81b can be moved along the groove SL provided in the barrel body 79a in the direction of the optical axis OA. The zoom pin 81b slides along the cam groove provided in the inner surface of the zoom ring 89c, which fits around the outer circumference of the barrel body 79a, so that the position to which the support 78c or the third group 73 is moved is adjusted. The fourth group 74 has a zoom pin 81c provided on the outer circumference of the support 78d for supporting the fourth group 74. The zoom pin 81c can be moved along the groove SL provided in the barrel body 79a in the direction of the optical axis OA. The zoom pin 81c slides along the cam groove provided in the inner surface of the zoom ring 89c, which fits around the outer circumference of the barrel body 79a, so that the position to which the support 78d or the fourth group 74 is moved is adjusted. The fifth group 75 has a zoom pin 81d provided on the outer circumference of the support 78e for supporting the fifth group 75. The zoom pin 81d can be moved along the groove SL provided in the barrel body 79a and the support 78d in the direction of the optical axis OA. The zoom pin 81d slides along the cam groove provided in the inner surface of the zoom ring 89c, which fits around the outer circumference of the barrel body 79a, so that the position to which the support 78e or the fifth group 75 is moved is adjusted.

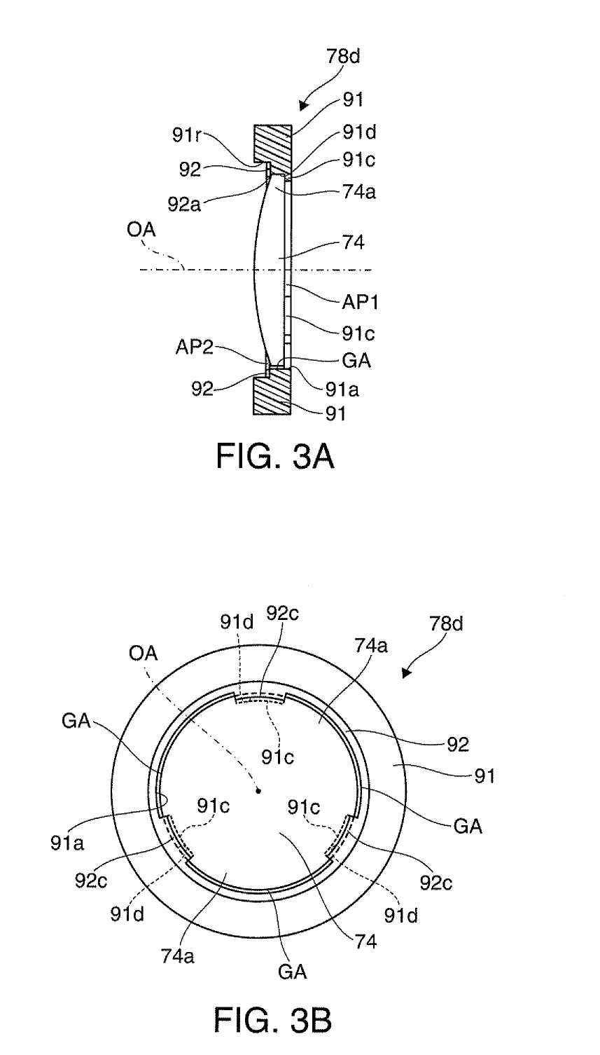

FIG. 3A is a side cross-sectional view for describing a method for supporting the fourth group 74 in the projection system 70, and FIG. 3B is a front view of the fourth group 74. The fourth group 74 is disposed on the image side of the diaphragm ST in the nearest position therefrom, where a projection light flux LP tends to converge and the fourth group 74 therefore tends to be heated. On the other hand, issues of cost and fixation stability do not always allow the diameter of the fourth group 74 to be readily increased. Further, the distribution of the projection light flux LP, which passes through the fourth group 74, greatly changes in zooming operation. In consideration of the situation described above, when the fourth group 74 is supported in the same manner as the other lens groups 71 to 73 and 75 to 77 supported by using a method in related art, the projection light flux LP tends to be blocked outside the outer circumference 74a of the fourth group 74, and hence the support for supporting the fourth group 74 tends to be heated. To address the problem, in the present embodiment, the support 78d for supporting the fourth group 74 has a special structure in which the outer circumference 74a of the fourth group 74 is not totally supported but is partially supported.

As shown in FIGS. 3A and 3B, the support 78d includes an annular portion 91, which is a main body, and a locking ring 92 for fixing purposes. The annular portion 91 and the locking ring 92 have openings AP1 and AP2, respectively, through which the projection light flux LP passes. The locking ring 92 fits in an annular step 91r provided in the annular portion 91 and fixed thereto with an adhesive. The inner diameters of the annular portion 91 and the locking ring 92 are larger than the outer diameter of the fourth group 74, and elongated, arcuate gaps GA are formed at three circumferential locations between the outer circumference 74a of the fourth group 74 and the inner circumferences 91a and 92a of the annular portion 91 and the locking ring 92. The annular portion 91 further has arcuate support protrusions 91c at three circumferential locations. The inner end of each of the support protrusions 91c extends inward beyond the outer circumference 74a of the fourth group 74 toward the optical axis OA, whereby the outer circumference 74a of the fourth group 74 can be supported on the object side. The locking ring 92 has arcuate tabs 92c at three circumferential locations in the positions corresponding to the support protrusions 91c. The inner end of each of the tabs 92c extends inward beyond the outer circumference 74a of the fourth group 74 toward the optical axis OA, whereby the outer circumference 74a of the fourth group 74 can be supported on the image side. Further, steps 91d are formed on the inner side of the support protrusions 91c of the annular portion 91, and the steps 91d support the outer circumference 74a of the fourth group 74 in the direction perpendicular to the optical axis OA. That is, the fourth group 74 is caught by the support protrusions 91c, the tabs 92c, and the steps 91d and stably held at the three circumferential locations.

As described above, in the projector 100 of the present embodiment, since the support 78d supports the outer circumference 74a of the fourth group 74, which is a lens adjacent to the diaphragm ST, in such a way that ventilation is partially allowed, the amount of light blockage outside the outer circumference of the fourth group 74 can be reduced, while the outer circumference of the fourth group 74, which is disposed adjacent to the diaphragm ST, is effectively used. In this way, the fourth group 74 and the support 78d for supporting the fourth group 74, which are disposed adjacent to the diaphragm ST and where the projection light flux LP tends to converge, will not be heated, whereby the lens in the fourth group 74 and the support 78d for supporting the lens will not be distorted due to expansion thereof. That is, the performance of the projection system 70 can be maintained at a high level at all times.

While the invention has been described above with reference to the embodiment, the invention is not limited thereto. The invention can be implemented in a variety of aspects to the extent that they do not depart from the substance of the invention. For example, the following variations can be employed.

For example, in the embodiment described above, the support 78d for supporting the fourth group 74 partially supports the outer circumference 74a of the lens in the fourth group 74, which is disposed on the image side of the diaphragm ST in the nearest position therefrom. Alternatively, the support 78e for supporting the fifth group 75 may partially support the outer circumference of the lens in the fifth group 75, which is disposed on the object side of the diaphragm ST in the nearest position therefrom.

Further, in the embodiment described above, the support 78d supports the outer circumference 74a of the lens in the fourth group 74 at three locations. The number of support points, the positions thereof, and other parameters can be changed as appropriate in accordance with, for example, how the lens in the fourth group 74 or any other lens group is used.

In the embodiment described above, the outer circumference 74a of the lens in the fourth group 74 is sandwiched between the arcuate support protrusions 91c and tabs 92c. The shapes of the support protrusions 91c and the tabs 92c can be arbitrarily determined to the extent that they unlikely prevent the projection light flux LP from passing through the lens in the fourth group 74.

The above description has been made on the assumption that the projection system 70 is a zoom lens. Even when the projection system 70 is not a zoom lens, light blockage tends to occur outside the outer circumference at a lens disposed in the vicinity of a diaphragm. In this case as well, a support similar to the support 78d described above and partially supporting the circumference of the lens can prevent the lens from being heated.

In the projector 100 of the embodiment described above, the pair of lens arrays 31 and 32 are used to divide the light from the light source lamp unit 20 into a plurality of sub-light fluxes. Alternatively, the lens arrays can be replaced with a rod integrator.

The projector 100 of the embodiment described above includes the polarization conversion member 34, which converts the light from the light source lamp unit into light polarized in a specific direction. The invention is also applicable to a projector that does not include the polarization conversion member 34. Further, the arc tube 22a in the light source lamp unit 20 may be replaced with an LED or any other suitable light source.

Projectors can be classified into front-projection projectors in which an image is projected from the viewer's side, where the viewer observes a projection surface, and rear-projection projectors in which an image is projected from the side that is opposite the viewer's side, where the viewer observes a projection surface. The configuration of the projector 100 shown in FIG. 1 and other figures can be used in either of the types described above.

The above embodiment has been described only with reference to the projector 100 using the three liquid crystal light valves 50a, 50b, and 50c. The invention is also applicable to a projector using one or two light valves and a projector using four or more light valves.

In the embodiment described above, the liquid crystal panels 51a, 51b, and 51c are transmissive ones, but the invention is also applicable to a reflective liquid crystal panel. The “transmissive” used herein means that the liquid crystal panel transmits light, whereas the “reflective” used herein means that the liquid crystal panel reflects light.

In the embodiment described above, the liquid crystal panels 51a, 51b, and 51c and other components are used to perform light modulation for each color. To modulate and combine color light fluxes, the liquid crystal panels 51a, 51b, and 51c can be replaced, for example, with the combination of a color wheel illuminated by the illuminator 10 and a device (light valve) formed of micromirror pixels and illuminated with the light having passed through the color wheel.

The entire disclosure of Japanese Patent Application No. 2010-075012, filed Mar. 29, 2010 is expressly incorporated by reference herein.

What is claimed is:

1. A projector comprising:
an illuminator that emits illumination light;
a light modulator that modulates the illumination light emitted from the illuminator; and
a projection system that includes a plurality of lenses and a diaphragm and projects the light modulated by the light modulator,
wherein the projection system includes a support that supports at least one of the following lenses: a lens located on the object side of the diaphragm in the nearest position therefrom and a lens located on the image side of the diaphragm in the nearest position therefrom, and
the support partially supports the outer circumference of the lens.

2. The projector according to claim 1,
wherein the support is made of a resin.

3. The projector according to claim 1,
wherein a gap that allows ventilation is created between the support and the outer circumference of the lens.

4. The projector according to claim 1,
wherein the support supports the outer circumference of the lens at a plurality of circumferential locations spaced apart from each other.

5. The projector according to claim 1,
wherein the projection system is a zoom lens in which the distances between the plurality of lenses are relatively changed.
